(19) United States
(12) Patent Application Publication
(10) Pub. No.: US 2015/0271330 A1
(43) Pub. Date: Sep. 24, 2015

(54) SYSTEM AND METHOD FOR RECORDING AND REPORTING COMPLIANCE DATA

(71) Applicant: NICE-SYSTEMS LTD., Ra'anana (IL)

(72) Inventors: Omer EREL, Cresskill, NJ (US); Tamir Levy, Netanya (IL); Ofir Roth, Kfar Saba (IL)

(73) Assignee: NICE-SYSTEMS LTD., Ra'anana (IL)

(21) Appl. No.: 14/267,638

(22) Filed: May 1, 2014

Related U.S. Application Data
(60) Provisional application No. 61/968,521, filed on Mar. 21, 2014.

(51) Int. Cl. H04M 3/51

(52) U.S. Cl. CPC H04M 3/5175

(57) ABSTRACT

A system and method for reporting invalid recordings of interactions. An interaction exchange list of interactions may be received that is transferred from an interaction exchange, e.g. to a contact center. A recorded interaction list may be generated listing recorded interactions stored in a memory. Records from the interaction exchange list may be matched with records from the recorded interaction list. For each record in the interaction exchange list, if a matching record from the recorded interaction list is found, it may be determined if the associated recorded interaction is operational. If no matching record is found or if the associated recorded interaction is determined to be non-operational, the associated recorded interaction may be reported as invalid.

### CROSS-REFERENCE TO RELATED APPLICATION DATA

This application claims the benefit of prior U.S. provisional application No. 61/968,521, filed on Mar. 21, 2014, which is incorporated herein by reference in its entirety.

### FIELD OF THE INVENTION

Embodiments of the invention relate to systems and methods for recording, storing, analyzing and reporting compliance information used to show that contact centers are compliant with industry or consumer regulations, for example, by recording all customer-agent interactions.

### BACKGROUND OF THE INVENTION

Company call centers or online support forums put customers in contact with company agents for customer service, for example, to provide technical support, sell products or schedule appointments. These contact centers face increasing regulatory pressure to adhere to consumer compliance regulations, retain records and strengthen compliance management system.

The Consumer Financial Protection Bureau (CFPB) prioritizes consumer compliance as an important element of contact center risk management, and recently imposed penalties on leading financial institutions which were not compliant.

The contact center, as compared to a back office for example, is naturally the “front line” interface to customers and provides the highest number of interactions with customers. Therefore, contact centers are more inclined to have the most consumer compliance infractions.

According to CFPB regulations, financial organizations need to record interactions, keep historical interaction records, and be able to retrieve and analyze historical calls or interactions. CFPB regulations require organizations to store and keep records of all (100%) of interactions, and provide a reliable mechanism to prove that compliance.

There is therefore a great need in the art and it would be highly useful to have a system and method to track and report compliance data associated with the regulated compliance practices of contact centers.

### SUMMARY OF THE INVENTION

The aforementioned problems in the art are resolved herein by providing a device, system and method to reliably record substantially all contact center interactions and to provide proof of said recording in compliance with consumer regulatory guidelines. According to an embodiment of the invention, a device, system and method may correlate and compare a contact center's internal interaction records against interaction exchange records of a public interaction exchange (e.g. call detail records (CDR) produced by a telephone or private branch exchange (PBX) or other telecommunications equipment) to detect any discrepancy in the records. When there are no discrepancies between the records (e.g. each interaction exchange record correlates to a contact center record), this information may be reported as proof of regulatory compliance that all interactions transferred from the exchange were recorded by the contact center. However, when there are discrepancies in which an interaction exchange record has no correlated contact center record, the missing interaction may be identified, for example, as not recorded, lost, damaged, incomplete or transferred to another contact center or storage facility. Further, if the records match, it may be determined if the underlying recording is operational. Missing or non-operational interactions may be reported as invalid to the customer, agent and/or regulatory service and a follow-up procedure may be automatically prompted to correct the invalid interaction, e.g., by initiating and recording a new interaction with the customer.

In one embodiment of the invention, an interaction exchange list of interactions may be received that is transferred from an interaction exchange, e.g. to a contact center. A recorded interaction list may be generated listing recorded interactions stored in a memory. Records from the interaction exchange list may be matched with records from the recorded interaction list. For each record in the interaction exchange list, if a matching record from the recorded interaction list is found, it may be determined if the associated recorded interaction is operational. If no matching record is found or if the associated recorded interaction is determined to be non-operational, the associated recorded interaction may be reported as invalid.

In one embodiment of the invention, interactions transferred from an interaction exchange may be recorded at a contact center. Interaction exchange records may be correlated with contact center records of the interactions. If there is a discrepancy between the records such that there is an extra interaction exchange record that has no correlated contact center record, a contact center recording of the interaction associated with the extra interaction exchange record may be identified as missing. For each interaction in which there is no discrepancy between the interaction exchange record and contact center record, it may be determined if the interaction recording associated with the contact center record is operational or non-operational.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates a system for recording and reporting customer interaction compliance data in accordance with an embodiment of the invention;

FIG. 2 is a flowchart of a process for recording and reporting customer interaction compliance data according to an embodiment of the invention;

FIG. 3 shows a user interface for initiating a comparison between interaction exchange records and contact center records of interactions recorded by a contact center recording device according to an embodiment of the invention;

FIG. 4 shows an interaction exchange list displaying records of interactions routed from the interaction exchange server according to an embodiment of the invention;

FIG. 5 shows a recorded interaction list displaying records of interactions recorded by the contact center recording device according to an embodiment of the invention;

FIG. 6 shows an output list reporting records of “missing” interactions according to an embodiment of the invention;

FIG. 7 shows an output list reporting records of interactions with non-operational recordings according to an embodiment of the invention;

FIG. 8 shows a user interface for receiving user-selected parameters that may be used for example to generate an interaction exchange list (FIG. 4), a recorded interaction list (FIG. 5), an output list of missing interactions (FIG. 6), and/or an output list of non-operational interaction recordings (FIG. 7) according to an embodiment of the invention;

FIG. 9 shows a user interface for running a reporting tool according to an embodiment of the invention; and

FIG. 10 is a flowchart of a method for reporting invalid interaction recordings that are missing or non-operational in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

When used herein, an “interaction” may refer to voice or data communication between users (e.g., agents, users, customers) or automated agents using devices and networks beyond the “plain old telephone system” (POTS), such as voice over Internet Protocol (VoIP) using personal computers. In various embodiments, interaction exchange records and contact center record may have a one-to-one correspondence, multiple interaction exchange records may correspond to one contact center record (e.g. when multiple users are routed to the same group call), or a single interaction exchange record may correspond to multiple contact center records (e.g. when a user is transferred between multiple contact center agents). An “interaction” may be initiated by a person taking action, for example, using a traditional telephone or other device such as a VoIP telephone, cellular telephone, computer, or other device, to speak or interact with another person. Further, embodiments of the invention may allow for a user to contact an agent via other methods, such as on-line chat, electronic mail (e-mail), text messaging, or other Internet interactions. “Interactions” may be conducted using a process or processor, for example, by executing a software process, requesting a software process perform some function or return some result, etc.

Embodiments of the invention may provide a recording compliance correlation tool. This tool may provide the ability to easily and reliably confirm that an interaction recording device records and stores all (e.g. 100%) or substantially all (e.g. 99% or more) interactions routed, handled and/or transferred by an interaction exchange (e.g. the PBX). Embodiments of the invention may identify gaps or discrepancies between the interactions reported by the interaction exchange (e.g. the interactions routed to the call center) and the interactions that were actually recorded by the call center recording device.

Embodiments of the invention may track an interaction comparison criterion which measures the correlation between interactions reported by the interaction exchange and interactions reported by the recording device to detect any discrepancies and identify missing interaction recordings. The interaction comparison criterion may be analyzed to count the number or percentage of missing interactions. When the interaction comparison criterion is zero or below a threshold value, it may be reported to prove that the recording device recorded all incoming and/or outgoing interactions, for example, in compliance with CFPB regulations. When the interaction comparison criterion is above a threshold value, the number, percentage or interaction details of the missing interaction recordings may be reported.

Embodiments of the invention may track an exception criterion which defines interactions that are non-operational, e.g., lost, damaged, incomplete, or transferred away. When the exception criterion defines one of a predefined non-operational exceptions (e.g. no audio, no channel found, damaged recording, recording will not play) with an interaction recording, the interaction recording may be reported as non-operational or invalid.

An “invalid” interaction recording may include interaction recordings that are “missing” or “non-operational.” “Missing” interaction recordings may include interactions that have no associated contact center record or metadata (e.g. interactions which were reported by the interaction exchange, but were not reported by the contact center recording device). “Non-operational” interaction recordings may have contact center records, but no actual recordings (e.g. lost interactions), or interactions having compromised recordings (e.g. damaged or partial recordings). Any “invalid” interaction recorded may be identified and automatically reported, for example, to the interacting user, agent, supervisor, regulatory group or other predefined subscriber.

In some embodiments, when invalid interactions are detected, the contact center may initiate a follow-up interaction with the interacting user. In one embodiment, the contact center may send a request to the interacting user device (e.g. to the number or Internet Protocol (IP) address of the calling party identified in the interaction exchange record) for each invalid interaction and may record a new interaction with the user device. The new interaction may be used to correct non-compliant data, e.g. by updating the interaction comparison criteria to reflect that the new recorded interaction was successfully recorded, by replacing the invalid interaction with the new recorded interaction, and/or by correlating the new recorded interaction with the contact center record or identification code for the invalid interaction.

The recording compliance correlation tool may be implemented as a monitoring tool in the recording device, or as an integral part of a compliance solution package that may be added to conventional recording devices and/or systems. This recording compliance correlation tool may function as a “monitor of the monitoring” center, which may be integrated in all deployed monitoring tools in contact centers, to track and alert a customer or client, an agent and/or a regulatory agency upon an indication of an invalid recording. The correlation tool may serve as a key element to monitor recording systems for the customer or client. The “monitoring” system may be offered as a periodic service (e.g. an annual maintenance service) to users who select to monitor their own or another user's interactions. Embodiments of the invention may generate customized reports for users that pinpoint specific interactions for which an interaction exchange record (e.g. a call detail record from the PBX) does not have a corresponding contact center record from the recording device.

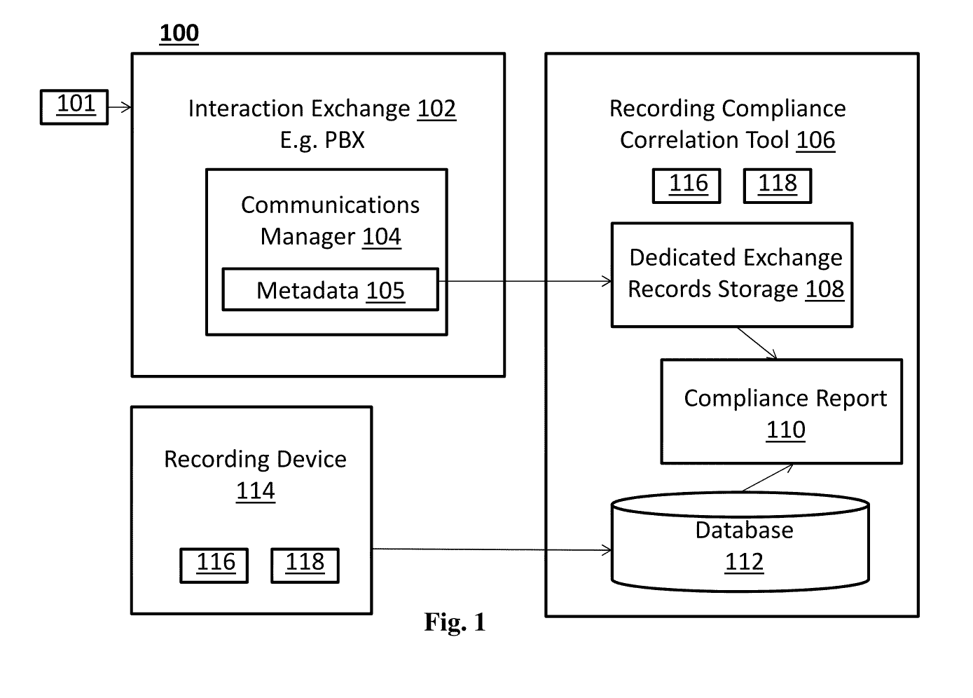

Reference is made to FIG. 1, which schematically illustrates a system 100 for recording and reporting customer interaction compliance data in accordance with an embodiment of the invention.

System 100 may include an interaction exchange 102 for connecting communication devices 101 over an exchange network, such as the PBX or other telephony, VoIP, or Internet exchanges. Interaction exchange 102 may include a communications manager 104 that stores and reports records of interaction between devices 101 over the exchange e.g. as interaction exchange records. Communications manager 104 may include a process or processor to automatically retrieve and transfer interaction exchange records, e.g., continuously or on a regular scheduled-basis, to a recording compliance correlation tool 106 implemented according to embodiments of the invention. Interaction exchange records may be stored and transferred as interaction metadata 105 from interaction exchange 102.

Recording compliance correlation tool 106 may receive the interaction exchange records and store them locally in a dedicated exchange records memory 108. Recording compliance correlation tool 106 may also store contact center records of interactions recorded by a recording device 114 in a database 112. Recording compliance correlation tool 106 may generate a compliance report 110 specifying the correlation between interaction exchange records from interaction exchange 102 and contact center records from recording device 114. When the records correlate exactly (e.g. every record stored in dedicated exchange records memory 108 matches a record in database 112, with a one-to-one, one-to-many, or many-to-one correlation), recording compliance correlation tool 106 may generate a positive compliance report 110 specifying full compliance of recording device 114. However, when there is a discrepancy between the records, recording compliance correlation tool 106 may generate a negative compliance report 110 for recording device 114 specifying records of “missing” or “non-operational” invalid recorded interactions and may alert the customer, agent or regulatory services e.g. at device 101 thereof. Reports may specify compliance for one or more predefined users, groups or users, or all contact center users e.g. within a predefined time interval.

In one embodiment, interaction exchange 102 may report or transfer interaction exchange records to a dedicated folder or other storage location e.g. via a secure File Transfer Protocol (sftp) server. Recording compliance correlation tool 106 may retrieve the interaction exchange records from interaction exchange 102 and normalize the information to correlate to the contact center records stored in database 112.

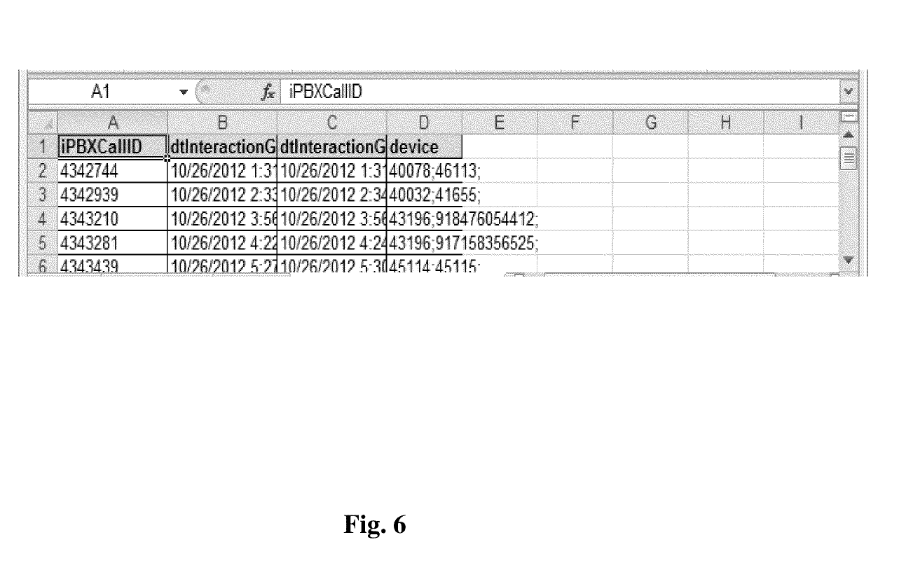

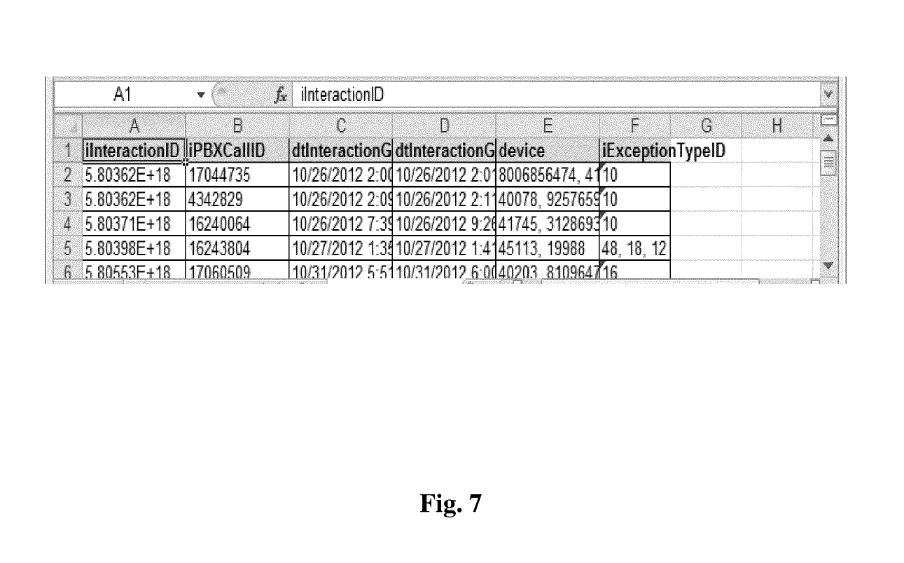

Recording compliance correlation tool 106 may compare or correlate the normalized interaction exchange records extracted from interaction exchange 102 and the contact center records stored in database 112 to detect any differences. In one embodiment, the comparison may proceed as follows:
A contact center identification (e.g. a Terraria Application Programming Interface (tAPI) Call identification (“ID)) may be stored in database 112 (e.g. in a iPBXCallID column of an interactions table).
An exchange identification may be extracted from the interaction exchange records (e.g. CDRs) stored in memory 108 (e.g. in globalCallID_callId fields) and translated or transformed to a corresponding contact center identification. Once the interaction exchange and contact center identifications are correlated, the corresponding interaction exchange records (stored in exchange records memory 108) and contact center records (stored in database 112) may be compared.
Recording compliance correlation tool 106 may perform a comparison between the interaction exchange and contact center records to verify the correlation and full recording of the interaction by the contact center. Recording compliance correlation tool 106 may compare one or more interaction details for interaction records having the same call identification information from both exchange records memory 108 and database 112, such as, a user or device identifier involved in the interaction, the number of segments in the interaction, the interaction or segment duration, start time and/or stop time, the interaction date, or other details. If recording compliance correlation tool 106 detects a discrepancy between the records such that there is an extra interaction exchange record that has no correlated contact center record, recording compliance correlation tool 106 may identify, mark or flag a contact center recording of the interaction associated with the extra interaction exchange record as missing, or possibly missing pending confirmation by a contact center agent. If an agent manually identifies the proper recording and the recording successfully undergoes the above comparison, the missing interaction may be re-classified as found (e.g. decrementing the interaction comparison criterion). In cases where recording compliance correlation tool 106 detects a discrepancy in the details of the records for a call identification, recording compliance correlation tool 106 may generate or output a list of interactions under this call identification (e.g. tAPI Call ID) (e.g. FIG. 6).
Recording compliance correlation tool 106 may also analyze the underlying interaction recordings to determine if they are operational. For each interaction in which there is no discrepancy between the interaction exchange record and contact center record, recording compliance correlation tool 106 may determine if the interaction recording associated with the contact center record is operational. Recording compliance correlation tool 106 may analyze interaction fields or parameters, for example, referred to as “exceptions,” that are associated with the operation and function of each recording in the interaction database. Exceptions may identify interactions for which there is a record or metadata, but where the recording failed to capture interaction content (e.g. speech or audio data in voice interactions). Example of exception values include: no channel found to record the interaction, interaction was partially recorded, interaction was recorded without audio, etc. If there is no difference in the interaction details between the records, but there is an exception defined for the recording in database 112, the recording compliance correlation tool 106 may add the record to an output list of interactions or segments having non-operational recordings (e.g. FIG. 7).

Interaction exchange 102, recording compliance correlation tool 106, and recording device 114, may each include one or more controller(s) or processor(s) 116 for executing operations and one or more memory unit(s) 118 for storing data and/or instructions (e.g., software) executable by a processor. Processor(s) 116 may be configured to perform the methods described herein by for example executing code or instructions stored in memory 118. Processor(s) 116 may include, for example, a central processing unit (CPU), a digital signal processor (DSP), a microprocessor, a controller, a chip, a microchip, an integrated circuit (IC), or any other suitable multi-purpose or specific processor or controller. Memory unit(s) 118 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units.

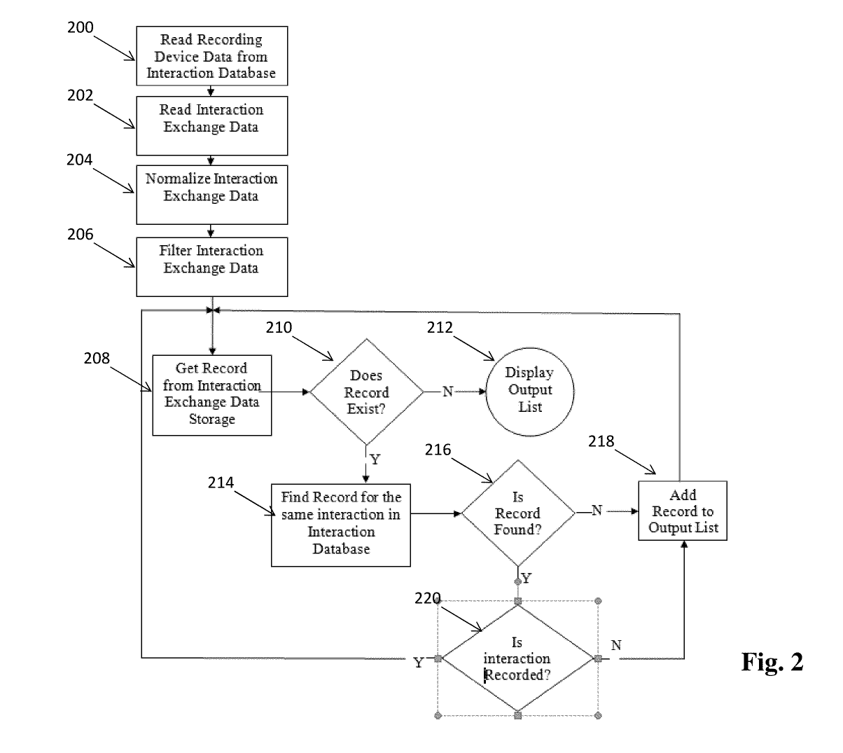

Reference is made to FIG. 2, which schematically illustrates a flowchart of a method for recording and reporting customer interaction compliance data in accordance with an embodiment of the invention. Operations described in reference to FIG. 2 may be executed using devices described in reference to FIG. 1 e.g. recording compliance correlation tool 106 or a processor 116 thereof.

Interaction exchange 102 may be configured to automatically transfer interaction exchange records, for example, continuously or on a regular scheduled-basis, such as, periodically, to the contact center recording compliance correlation tool 106. Interaction exchange records may be stored in exchange records memory 108, e.g. in a dedicated folder using sftp located in or recording compliance correlation tool 106. Recording compliance correlation tool 106 may correlate and compare corresponding records from internal database 112 and exchange records memory 108 corresponding to the same interactions or interaction segments to create compliance report 110.

In operation 200, a processor may read contact center records of interactions recorded by a recording device at a contact center (e.g. recording device 114 of FIG. 1) and/or stored in an interaction database at a contact center (e.g. database 112 of FIG. 1). The processor may run an application to connect to the interaction database and read all records within a time range (e.g. a one-time or periodically repeating time interval) that may be specified by a user, such as, input into the application. The processor may create a contact center interactions list of those records.

In operation 202, a processor may read interaction exchange records from an interaction exchange server (e.g. interaction exchange 102 of FIG. 1) to identify information, such as, interaction exchange identification codes or numbers. The interaction exchange server may be configured to automatically push interaction exchange records, for example, continuously, periodically, or on a regular scheduled-basis, to an exchange records memory (e.g. exchange records memory 108 of FIG. 1) such as a specific folder using an sftp data transfer. The application may connect to the exchange records memory and read interaction exchange records within the same time range used in operation 200.

In operation 204, a processor may normalize information read from the interaction exchange records by converting the interaction exchange identification code (e.g. Call Manager ID and Call ID) to a contact center identification code (e.g. tAPI Call ID), for example, as follows:

```
/// <summary>
    /// converts identification code from interaction exchange record (e.g.
Call Manager ID and Call ID) into identification code for corresponding
contact center record (e.g. tAPI Call ID).
  /// </summary>
      /// <param name=“iCallManagerId”> reported in
interaction exchange report in column 1</param>
      /// <param name=“iCallId”> reported in interaction
exchange report in column 2</param>
      ///  <returns>output  is  tAPI  Call  ID  which  is  same
ID  reported  by  tAPI interface</returns>
  int ConvertExchangetoTapiCallID(int iCallManagerId, int iCallId)
  {
    return ((iCallManagerId & 0x03ff) << 22) | (iCallId & 0x003fffff);
  }
where iCallManagerId and iCallId are taken from the interaction exchange
records report (globalCallID_callId).
```

This formula or algorithm may be used to convert the interaction exchange record identification (e.g. iCallManagerId and iCallId) into the contact center identification (e.g. tAPI call ID) which is used by the contact center interface. In one example, the correlation between contact center interactions records and the interaction exchange records is based on the tAPI call ID.

The processor may retrieve all Date Time Connect and/or Date Time Disconnect information from interaction exchange records associated with the same interaction identification code and may sort these times. For each time range, the processor may collect interaction exchange information for all users with interactions occurring during this same interaction time range (e.g. in group interactions), and may merge their interaction information to correspond to a single (e.g. group) interaction. Users may be identified by callingPartyNumber and/or finalCalledPartyNumber fields in the interaction exchange records.

In operation 206, a processor may filter the interaction exchange information. In one example, the processor may select interaction information for all interaction exchange records that identify at least one monitored directory number (DN) and filter or delete the rest. The monitored DN list may be taken from a configuration file. Each interaction exchange record may correspond to an interaction or segment (e.g. a continuous user-agent session) recorded in the interaction database. After filtering the records, the processor may create an interaction exchange list e.g. of all relevant interactions to be monitored.

In operation 208, for each interaction in the interaction exchange list, a processor may retrieve the associated interaction exchange record from the interaction exchange storage (e.g. exchange records memory 108 of FIG. 1) for comparison with the contact center records in the contact center interactions list of operation 200.

In operation 210, a processor may determine if the interaction exchange record exists. If there are no more interaction exchange records, then the processor may proceed to operation 212 to display an output list. Otherwise, the processor may proceed to operation 214.

In operation 214, a processor may search the interaction database to find a corresponding or matching contact center record for the same interaction. The processor may compare record information, such as, date and/or time when the interaction was connected, date and/or time when the interaction was disconnect, calling party number, original called party number, and/or final called party number. The processor may determine that a contact center record corresponds to the retrieved interaction exchange record if their parameters match.

In operation 216, a processor may determine if a contact center record matches the retrieved interaction exchange record.

In operation 218, if a matching record is not found, a processor may add the contact center record to an output list of invalid interactions. Invalid interactions may be reported to a user (e.g. in compliance report 110 of FIG. 1).

In operation 220, if the corresponding record is found, a processor may check that the interaction recorded is operational. The processor may check that the recording is operational e.g. by analyzing its exception field(s) or attempting to play the recording and testing for any system errors. In one embodiment, the processor may determine interactions are non-operational with certain predefined exceptions (e.g. no audio or no channel found), but not with other exceptions (e.g. unmapped user, in which the interaction was recorded but the user is not defined in the system). If the interaction is non-operational, for example, lost, damaged, incomplete, or transferred away, the processor may add the interaction record to the output list of invalid interactions in operation 218.

These operations may be executed in a different order, some operations may be skipped or combined, and/or other operations may be added.

According to embodiments of the invention, a processor may monitor specific devices or interactions according to user-defined information. Recording compliance correlation tool 106 may execute a process to extract information for the relevant monitored interaction exchange records from the interaction exchange list as follows (a processor may retrieve all records, but may select a subset of those to monitor, e.g., associated with monitored devices or other user-defined monitoring parameters, such as, monitored devices associated with all tAPI interfaces):
Select or filter interaction exchange records associated with interactions that occurred within a predefined period of time to select a subset of records to be monitored.
Group selected interaction exchange records according to their associated interaction exchange ID.
Collect all dateTimeConnect and dateTimeDisconnect fields from interaction exchange records associated with the same interaction exchange ID and sort these times chronologically.
For each time range, collect identifiers for all user devices that participated in the interaction(s) during this time range (e.g. callingPartyNumber or finalCalledPartyNumber) and merge their records.
Select or filter interaction exchange records based on predefined user devices to select a subset of records to be monitored. For example, select all interactions or records associated with at least one predefined monitored DN. Filter out the rest.
Determine if each interaction exchange record identifies an interaction that is equivalent to an interaction or segment in the contact center recorded interaction database.

In one example, embodiments of the invention may operate according to the following guidelines:

It may be assumed that there are several interaction exchange records that have the same dateTimeConnect and dateTimeDisconnect values (e.g. in Conference Bridge systems). There may still be cases in conference scenarios in which this assumption is not true and this assumption may be validated by the interaction exchange. In some embodiments, interactions may only be recorded that are longer than a threshold duration, such that if the segment is shorter than that threshold, the recording compliance correlation tool may ignore it. In one example, the interaction exchange records below show a conference segment having multiple calling parties (e.g. identified by different callingPartyNumbers 9358126, 1028 and 9358125, but the same interaction ID, dateTimeConnect and dateTimeDisconnect:

| callingParty | originalCalled | finalCalled | dateTime | dateTime |
|---|---|---|---|---|
| Number | PartyNumber | PartyNumber | Connect | Disconnect |
| 9358126 | b00104301036 | b00104301036 | 1361461932 | 1361461937 |
| 1028 | b00104301036 | b00104301036 | 1361461932 | 1361461937 |
| 9358125 | b00104301036 | b00104301036 | 1361461932 | 1361461937 |

Embodiments of the invention may support a general system architecture including each different interaction scenario including a sequence of transferred interactions or segments, conference or group interactions, or primary/secondary/primary interaction IDs (e.g., in a transfer scenario the first interaction is assigned call ID 11, the second interaction is assigned call ID 12 and the transferred interaction may be re-assigned the primary call id 11), etc.

The monitored device list may specify the devices (e.g. and/or extensions) for which compliance data may be included in the compliance report, for example, as follows.

Type: Hashset<string> MonitoredDevicesList.

Code executed by a processor to report all interaction exchange records:

```
  public class line
  {
  public long CallManagerId { get; set; }
  public long CallId { get; set; }
        public long dateTimeConnect { get; set; }
        public long dateTimeDisconnect { get; set; }
        public string callingPartyNumber { get; set; }
        public string finalCalledPartyNumber { get; set; }
        public long duration { get; set; }
        public string origDeviceName { get; set; }
        public string destDeviceName { get; set; }
        public long destConversationId { get; set; }
        public string huntPilotDN { get; set; }
}
```

Code executed by a processor to collect recorded contact center records from the interaction database:

```
public class record
{
    private HashSet<string> devices = new HashSet<string>( );
    public long CallId { get; set; }
    public long StartTime { get; set; }
    public long StopTime { get; set; }
    public HashSet<string> Devices { get { return devices; } }
```

The above code is provided for example only and is not mean to be limiting. Other code may be used to achieve similar results within the scope of embodiments of the invention.

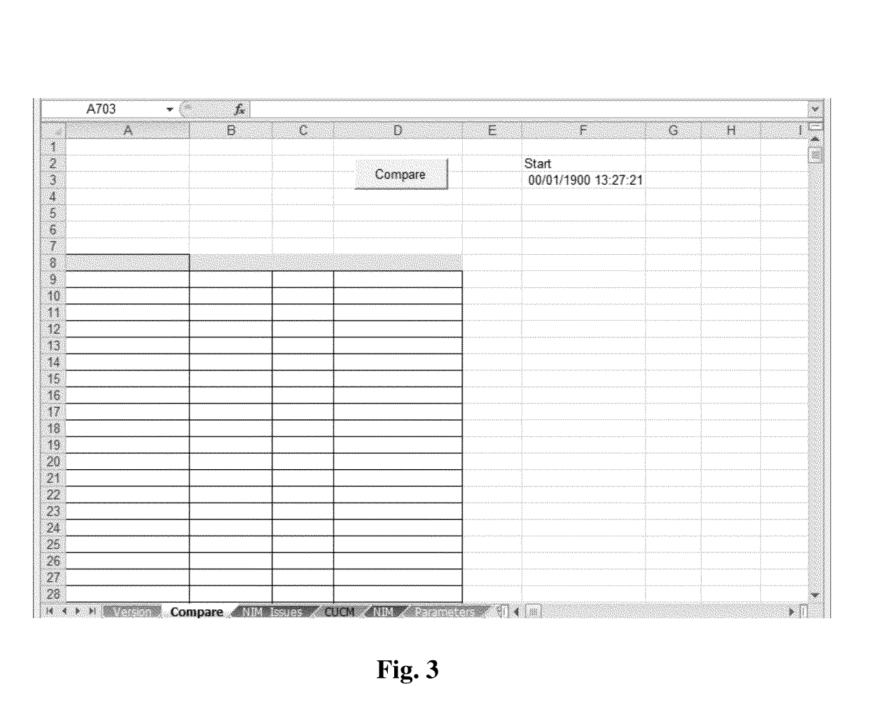

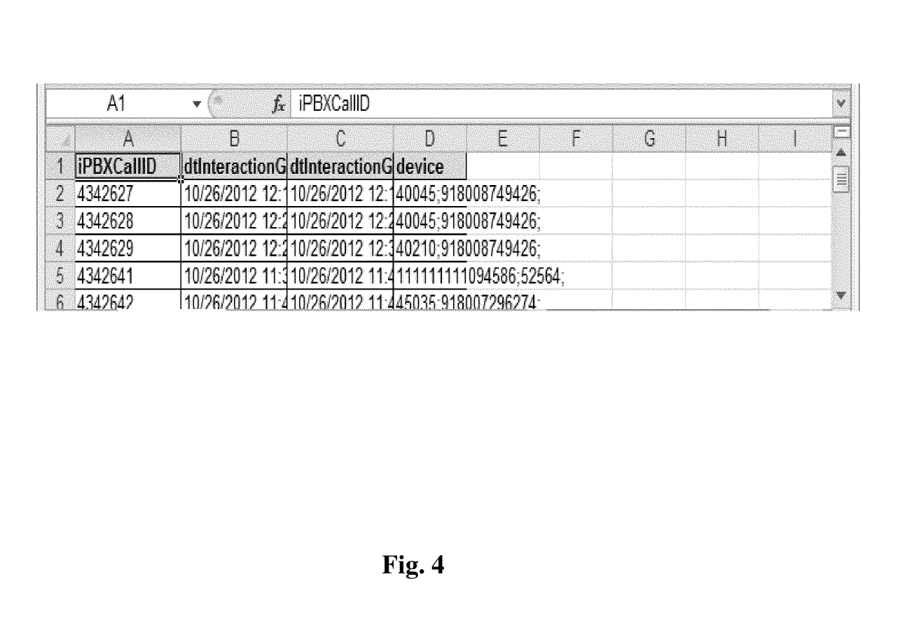

Recording compliance correlation tool 106 may receive contact center records from recorded interaction database 112 and may normalize interaction exchange records from the interaction exchange. Recording compliance correlation tool 106 may compare the interaction exchange records from memory 108 and recorded records from database 112 e.g. automatically upon downloading the records, periodically, when a threshold number of records are stored, or manually by a user when a compare button is pressed (e.g. as shown in FIG. 3). The interaction exchange records and contact center records and the result of the comparison may be reported to a user e.g. shown in FIGS. 4-7.

Reference is made to FIG. 4, which shows an interaction exchange list (e.g. generated in operation 206) displaying records of interactions routed from the interaction exchange server according to an embodiment of the invention. This list may be created using a user interface e.g. as shown in FIG. 7. The interaction exchange list may include all normalized interaction exchange records for interactions conducted within in specific time range e.g. as specified in the user interface.

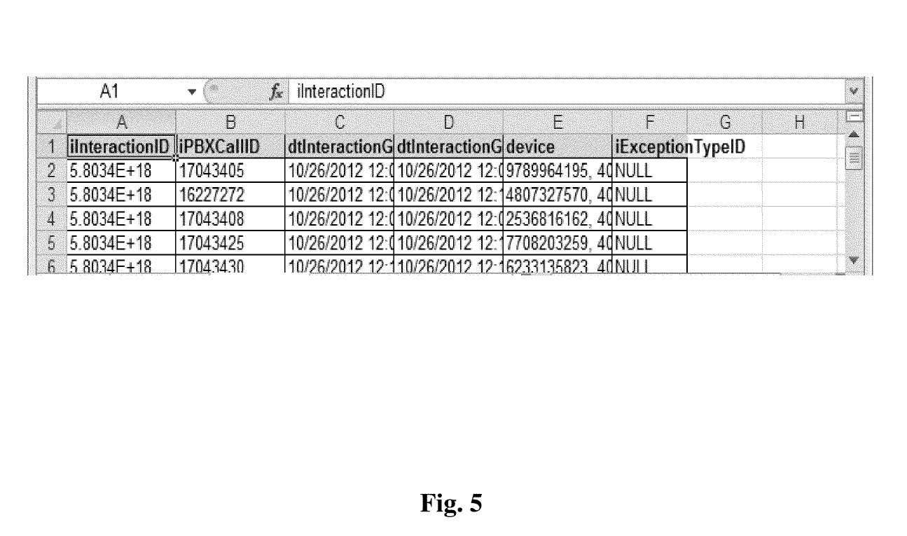

Reference is made to FIG. 5, which shows a contact center interaction list (e.g. generated in operation 200) displaying records of interactions recorded by the contact center recording device (e.g. device 114 of FIG. 1) and/or stored in an interaction database in the contact center (e.g. database 112 of FIG. 1) according to an embodiment of the invention. This list may be created by a processor sending a query to the interaction database for contact center records that occurred within a specific time period e.g. as specified in the user interface shown in FIG. 7.

Reference is made to FIG. 6, which shows an output list reporting records of “missing” interactions according to an embodiment of the invention. Missing interactions including interactions that are in the interaction exchange list of FIG. 4, but not in the contact center interaction list of FIG. 5.

Reference is made to FIG. 7, which shows an output list reporting records of interactions with non-operational recordings according to an embodiment of the invention. The output list may report interaction recordings as “non-operational” when the interaction has a record in the recorded interaction list of FIG. 5, but has a recording that is damaged, corrupted or otherwise not operational. Invalid recordings may be indicated by predefined invalid exception fields, such as, no audio, no channel, partial recording, etc.

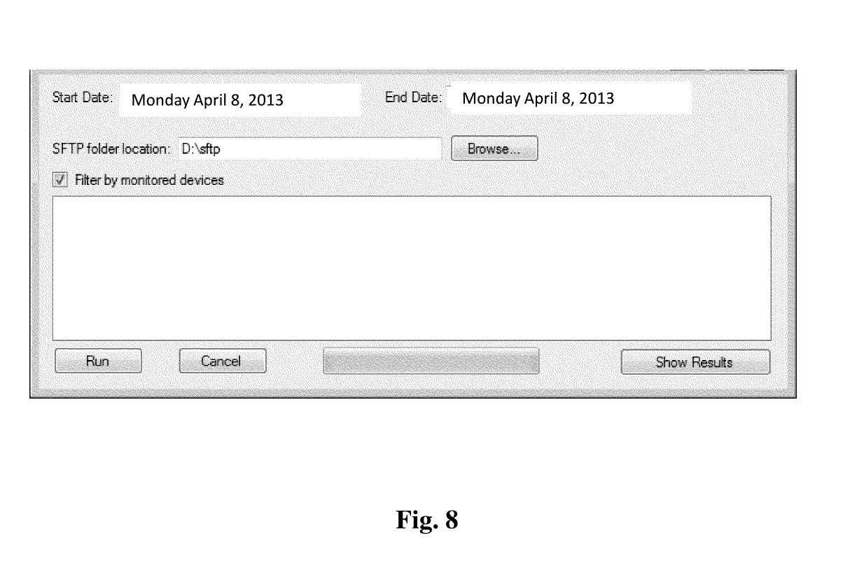

Reference is made to FIG. 8, which shows a user interface for receiving user-selected parameters that may be used for example to generate an interaction exchange list (FIG. 4), a recorded interaction list (FIG. 5), an output list of missing interactions (FIG. 6), and an output list of non-operational interaction recordings (FIG. 7). The user interface may receive a user-specified time period within which interaction exchange records are retrieved from the interaction exchange. The user interface may be used to enter a memory location for exchange records memory 108 (e.g. a sftp folder location) to designate the destination location for transmitting the exchange interaction exchange records. The user interface provides an option to filter the search by monitored devices. The user interface may include a “Run” button, which when pressed, retrieves interaction exchange records from the interaction exchange that are associated with the selected parameters. Once the interaction exchange records are retrieved from the interaction exchange, a graphical user interface may display the interaction exchange records (e.g. FIG. 4). A similar search of the interaction database over the same time period may be run to extract contact center records of corresponding recorded interactions. A graphical user interface may display the corresponding contact center records of recorded interactions (e.g. FIG. 5). The records in the two output reports may be compared and a graphical user interface may display the uncorrelated records for missing interaction recordings (e.g. FIG. 6) and underlying non-operational interaction recordings (e.g. FIG. 7).

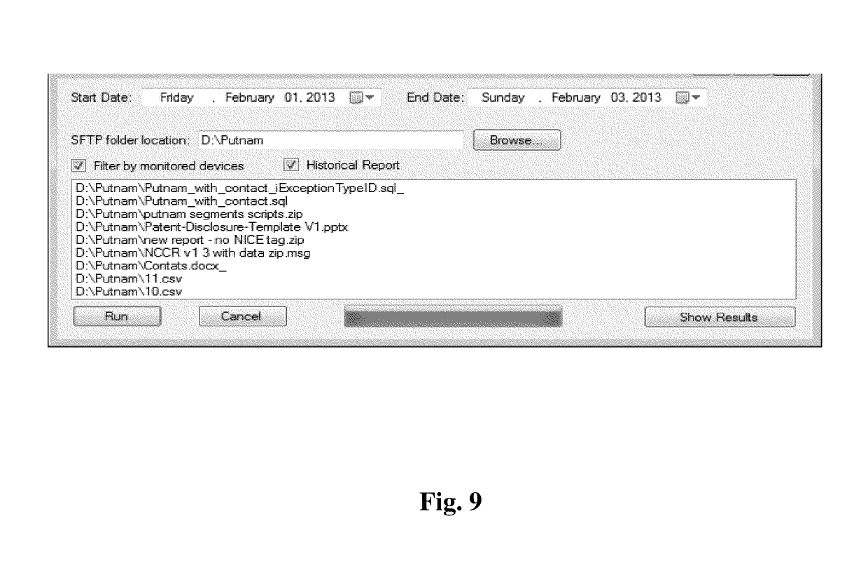

Reference is made to FIG. 9, which shows a user interface for running a reporting tool according to an embodiment of the invention.

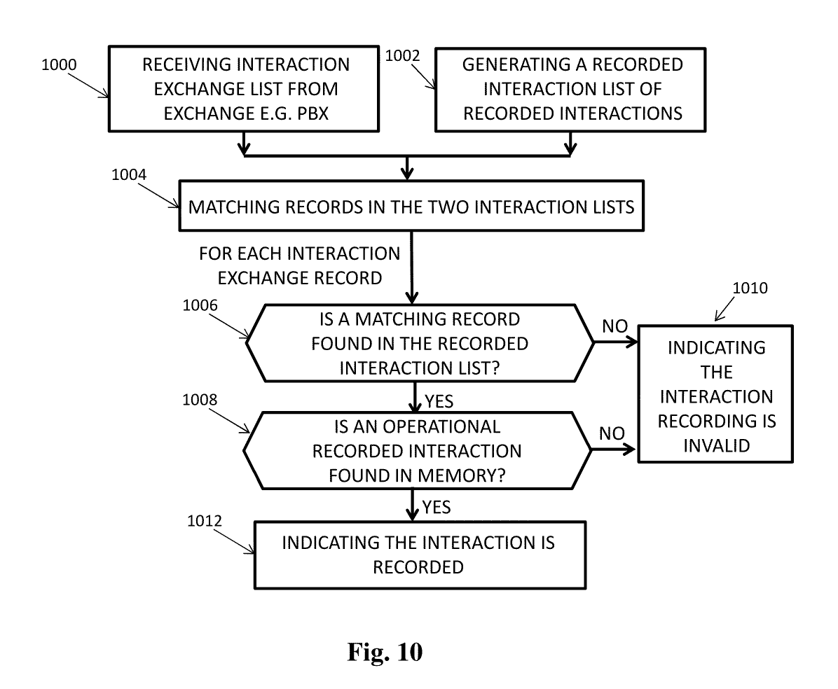

Reference is made to FIG. 10, which is a flowchart 1000 of a method for reporting invalid interaction recordings that are missing or non-operational in accordance with an embodiment of the invention. Operations described in reference to FIG. 2 may be executed using devices described in reference to FIG. 1 e.g. recording compliance correlation tool 106 or a processor 116 thereof.

In operation 1000, a processor may receive an interaction exchange list (e.g. as shown in FIG. 4) of interactions transferred from an interaction exchange (e.g. interaction exchange 102 of FIG. 1) to a recording compliance module or engine (e.g. recording compliance correlation tool 106 of FIG. 1).

In operation 1002, a processor may generate a recorded interaction list (e.g. as shown in FIG. 5) of interactions recorded (e.g. by recording device 114 of FIG. 1) and stored in a memory (e.g. database 112 of FIG. 1).

In operation 1004, a processor may compare, correlate, or match records from the interaction exchange list with records from the recorded interaction list. In one embodiment, the processor may sort the records in the interaction exchange list according to a start time and stop time of the interaction and may match records in the interaction exchange list with records in the recorded interaction list that have the same start time and stop time. For example, the processor may match two or more records in the interaction exchange list (e.g. corresponding to independent lines in a group or bridge call) with a single record in the recorded interaction list that has the same interaction identification, start time and stop time.

In operation 1006, a processor may determine if each record in the interaction exchange list matches or is correlated with a record from the recorded interaction list. For example, the processor may determine if there is an extra interaction exchange record that has no correlated contact center record. If not, the processor may indicate, mark, flag or otherwise report that the interaction recording associated with the extra interaction exchange record is missing or invalid. Correlating or matching two or more records may include determining that the records have equivalent values, e.g., interaction start and/or stop times and call identifications.

In operation 1008, when there is a record of an interaction recording, a processor may determine if the associated recorded interaction is stored in the memory and is operational.

In operation 1010, a processor may report that an interaction recording is invalid if the interaction is missing (e.g. as detected in operation 1006) or if the interaction is non-operational (e.g. as detected in operation 1008). For example, the processor may periodically report invalid recorded interactions to a user continually, upon request, or periodically according to a predefined reporting schedule.

In operation 1012, a processor may report that a valid recording exists for the interaction, for example, if both a recorded interaction record is found (in operation 1006) and an operational interaction recording is found (in operation 1008).

These operations may be executed in a different order, some operations may be skipped or combined, and/or other operations may be added.

It may be appreciated that although certain devices and functionality are assigned to “users,” “customers,” “clients,” “agents,” and “operators” these are only example scenarios and such functionality may be implemented by any users. The users may include two or more live users, two or more automated user(s) or a combination of live user(s) and automated user(s).

A “contact center” may refer to a network or group of two or more (e.g. tens or hundreds of) agents in contact with users on behalf of a group, company or entity. A contact center may or may not include a physical center and may include agents interacting remotely. Embodiments of the invention may be generalized to monitor and report interaction recording in recording systems other than contact centers.

An “interaction exchange” may refer to a public switching system for routing calls and other interactions over a network. Examples of interaction exchanges include private branch exchange (PBX) for standard telephone communication, Internet Exchanges (IX) that may include a Computer Telephony Integration (CTI) server for VoIP communication, etc. In one embodiment, a contact center may have one or more destination number(s) or IP address(es), and an interaction exchange may route interactions to the contact center as well as other destinations.

Some embodiments of the invention may provide a clear picture of the gap between physical calls (e.g. routed from the PBX) and recorded calls (e.g. at the call center).

Different embodiments are disclosed herein. Features of certain embodiments may be combined with features of other embodiments; thus certain embodiments may be combinations of features of multiple embodiments.

Embodiments of the invention may include an article such as a computer or processor readable non-transitory storage medium, such as for example a memory, a disk drive, or a USB flash memory encoding, including or storing instructions, e.g., computer-executable instructions, which when executed by a processor or controller, cause the processor or controller to carry out methods disclosed herein.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

1. A method for reporting invalid recordings of interactions, the method comprising:
receiving an interaction exchange list of interactions transferred from an interaction exchange;
generating a recorded interaction list of recorded interactions stored in a memory;
matching records from the interaction exchange list with records from the recorded interaction list;
for each record in the interaction exchange list:
if a matching record from the recorded interaction list is found, determining if the associated recorded interaction is operational; and
if no matching record is found or if the associated recorded interaction is determined to be non-operational, reporting that the associated recorded interaction is invalid.

2. The method of claim 1, wherein each record in the interaction exchange list is matched to a record in the recorded interaction list having the same one or more record parameters selected from a group consisting of: interaction identification, user device identification, number of segments in the interaction, interaction duration, interaction start time, interaction stop time, and interaction date.

3. The method of claim 1 comprising transforming an interaction identification of a record in the interaction exchange list to correlate with an interaction identification of a record in the recorded interaction list; and matching records having the same interaction identification.

4. The method of claim 1 comprising sorting the records in the interaction exchange list according to a start time and stop time of the interaction and matching records in the interaction exchange list with records in the recorded interaction list that have the same start time and stop time.

5. The method of claim 1 comprising matching two or more records in the interaction exchange list with a single record in the recorded interaction list that has the same interaction identification, start time and stop time.

6. The method of claim 1 comprising filtering the interaction exchange list based on predefined user devices and a predefined period of time to select a subset of records to be monitored.

7. The method of claim 1 comprising periodically reporting invalid recorded interactions according to a predefined reporting schedule.

8. The method of claim 1 comprising reporting a status of the invalid recorded interactions, wherein the status is selected from the group consisting of: not recorded, lost, damaged, incomplete, non-operational, and transferred.

9. The method of claim 1 comprising:
sending a request to initiate a new interaction with a user device interacting in the invalid recorded interaction;
recording the new interaction with the user device; and
verifying that the contact center stores a record and an operational recorded interaction for the new interaction.

10. A method for monitoring contact center recording, the method comprising:
at a contact center:
recording interactions transferred from an interaction exchange;
correlating interaction exchange records and contact center records of the interactions; and
if there is a discrepancy between the records such that there is an extra interaction exchange record that has no correlated contact center record, identifying that a contact center recording of the interaction associated with the extra interaction exchange record is missing.

11. The method of claim 10 comprising, for each interaction in which there is no discrepancy between the interaction exchange record and contact center record, determining if the interaction recording associated with the contact center record is operational.

12. The method of claim 11 comprising reporting that the interaction recording is non-operational.

13. The method of claim 11 comprising, if there are no discrepancy between the records and the interaction recordings are operational for all contact center records, reporting that all monitored interactions are recorded by the contact center.

14. The method of claim 11 comprising, before correlating the interaction exchange records:
retrieving a subset of interaction exchange records for interactions that occurred within a predetermined time period;
grouping interaction exchange records in the subset according to an interaction identification;
sorting the grouped interaction exchange records according to their interaction times; and
merging two or more of the sorted interaction exchange records that have the same interaction identification number and interaction times into a single interaction exchange record.

15. A system for reporting invalid recordings of interactions, the system comprising:
a recording device for recording interactions transferred from an interaction exchange;
a memory for storing the recorded interactions; and
a processor configured to generate records of the recorded interactions in a recorded interaction list, receive an interaction exchange list of interactions transferred from the interaction exchange, match records from the interaction exchange list with records from the recorded interaction list, wherein for each record in the interaction exchange list, if a matching record from the recorded interaction list is found, the processor is configured to determine if the associated recorded interaction is operational, and if no matching record is found or if the associated recorded interaction is determined to be non-operational, the processor is configured to report that the associated recorded interaction is invalid.

16. The system of claim 15 comprising a contact center recording compliance tool including the processor.

17. The system of claim 15, wherein the interaction exchange is a private branch exchange (PBX) for telephone interactions.

18. The system of claim 15, wherein the interaction exchange includes an Internet exchange (IX) including a computer telephony integration (CTI) server for voice over Internet Protocol (VoIP) communication.

19. The system of claim 15, wherein the processor is further configured to match each record in the interaction exchange list to a record in the recorded interaction list having the same one or more record parameters selected from a group consisting of: interaction identification, user device identification, number of segments in the interaction, interaction duration, interaction start time, interaction stop time, and interaction date.

20. The system of claim 15, wherein the processor is further configured to transform an interaction identification of a record in the interaction exchange list to correlate with an interaction identification of a record in the recorded interaction list; and match records having the same interaction identification.
